(19) United States
(12) Patent Application Publication
(10) Pub. No.: US 2022/0313003 A1
(43) Pub. Date: Oct. 6, 2022

(54) MATE TEA LID

(71) Applicant: Tierra Del Mate LLC, Portland, OR (US)

(72) Inventors: Roger D. Rowles, Portland, OR (US); Trevor M. Devos, Portland, OR (US)

(21) Appl. No.: 17/657,662

(22) Filed: Apr. 1, 2022

Related U.S. Application Data
(60) Provisional application No. 63/169,758, filed on Apr. 1, 2021.

(51) Int. Cl. A47J 31/44; B65D 43/02; B65D 77/28; B65D 51/24; A47J 31/00; A47J 31/20

(52) U.S. Cl. CPC A47J 31/4407; B65D 43/022; B65D 77/28; B65D 51/24; A47J 31/005; A47J 31/20; B65D 2543/00046; B65D 2543/00972

(57) ABSTRACT

An improved removable lid for use in steeping tea. The lid defining a receptacle between a lid floor and a lid wall. The lid floor having a plurality of filter openings configured for liquid drainage from the receptacle into a drinking vessel. The lid having a straw protuberance extending upward from the lid floor and configured with an opening for placement therethrough of a straw. The straw protuberance extending upward to prevent liquid from the receptacle from flowing out the opening of the straw protuberance. The lid is configured for nesting engagement with a drinking vessel, such as a mate gourd. The lid preferably has a vertical divider extending upward from the floor to divide the lid receptacle into two or more receptacles. A user can then place tea substrate into each receptacle and can spend the tea substrate in one sub-receptacle, then utilize the tea substrate in the remaining receptacle.

### CROSS-REFERENCE TO RELATED APPLICATIONS

This application claims the benefit of U.S. Provisional Application No. 63/169,758, filed Apr. 1, 2021 the disclosure of which is incorporated by reference.

### TECHNICAL FIELD

The claimed invention relates to a drinking lid. Specifically, the invention relates to a novel drinking lid that is to be utilized for drinking mate tea or similar drinks that steep liquid from a similar dried leave. The lid is specifically designed to allow a user to refill the drink numerous times while minimizing the need to remove the lid and thus reducing the likelihood of spillage.

### DISCLOSURE

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

### BACKGROUND

Mate tea is a traditional caffeine-rich infused drink. It is commonly prepared and served in a calabash drinking vessel container with a metal straw. It is prepared using the yerba mate (llex paraguariensis) plant leaves and hot water, similar to standard tea that utilizes a tea substrate, such as leaves, and hot water is added to the tea substrate, steeping the flavor and health-promoting compounds from the tea substrate.

Commonly, the first step in preparing the drink is to place the yerba mate into the drinking vessel and arrange it along one side thereof. After filling the drinking vessel with the yerba mate, a user will next cover the top opening of the drinking vessel with palm of their hand and shake the mixture vigorously, but briefly. This allows the finest particles of the yerba mate to settle toward the user's hand.

Next, a user tilts the drinking vessel nearly sideways so as to position all the yerba mate to one side of the drinking vessel. The user then gently shakes the drinking vessel side-to-side. This again helps to ensure the finest particles are near the top of the drinking vessel and not the bottom.

The next step is to add the straw. Traditional mate straws are known as bombillas. A bombilla straw is typically constructed of metal. The bombilla straw typically have some type of filtering device on the bottom end thereof, such as perforations, which serve to allow liquid tea to flow through the filter, while retaining any tea substrate larger than the filter opening in the drinking vessel. This is meant to minimize a user's sucking up of any particles from the yerba mate. The bombilla straw at the bottom end can typically be opened to allow a user to clean the perforated end.

Cold water may be added after the bombilla straw has been inserted to pack the yerba mate and help it maintain its shape. Finally, it is filled with hot water. The water preferably ranges from 70 to 85° C., but not boiling. A user can refill the drink with hot water numerous times. The purpose of the mate system is to allow a user to generate fresh tea on an ongoing basis, as opposed to generating a large pot or amount of tea.

### BRIEF DESCRIPTION OF THE FIGURES

FIG. 1 is a side orthographic view of an embodiment of a lid.

FIG. 2 is a side view of the embodiment of a lid of FIG. 1.

FIG. 3 is a section view of the lid of FIG. 1 along line A of FIG. 4.

FIG. 4 is a top view of the lid of FIG. 1.

FIG. 5 is a bottom orthographic view of the lid of FIG. 1.

FIG. 6 is a bottom view of the lid of FIG. 1.

FIG. 7 is an orthographic view of the lid of FIG. 1 nested in a drinking vessel and a straw extending through the lid.

FIG. 8 is a top orthographic view of the lid, drinking vessel, and straw of FIG. 7.

FIG. 9 is an orthographic section view of the lid and drinking vessel of FIG. 7.

### SUMMARY OF THE INVENTION

While certain exemplary embodiments are shown in the Figures and described in this disclosure, it is to be distinctly understood that the presently disclosed inventive concept(s) is not limited thereto but may be variously embodied to practice within the scope of this disclosure. From the following description, it will be apparent that various changes may be made without departing from the spirit and scope of the disclosure as defined herein.

Therefore, what is disclosed herein is a novel lid to be used for preparation of the mate tea. The lid is configured such that a user may pour the hot water directly thereon without having to remove the lid or the straw from the drinking vessel. The lid structure can minimize the risk of spilling a full drinking vessel. The lid structure will also minimize the effort needed during the refilling process, as the lid may remain attached while being refilled.

Accordingly, what is disclosed is a novel lid apparatus to be used for mate tea preparation and drinking. The mate lid is configured such that it is permeable to water being poured in from the top but is resistant to water and/or yerba mate leave particles from coming back out.

The mate lid preferably has a plurality of openings arranged across the floor of the lid structure. A wall extends from the edge of the floor structure. Preferably the wall has a circular cross section, although alternate shapes can be used dependent on the drinking vessel to which the lid is configured to attach. The plurality of openings can be of a variety of shapes and sizes. A straw support protuberance extends vertically from the floor of the lid. There is a large opening is positioned in the straw protuberance configured to receive a straw used for drinking the tea. The straw protuberance extends vertically so as to prevent liquid poured into the lid from seeping through the straw opening. In an embodiment, there is a vertical divider structure that transects the middle of the lid structure. Alternatively vertical dividers can divide the lid into a series of receptacles. The vertical divider preferably will extend from one end of the mate lid to the straw protuberance. In this embodiment, the straw opening is configured such that walls extend upward to the same height of the vertical divider.

The vertical divider may serve two primary purposes. The first, is it provides a gripping area for a user to grip and remove the lid. The second purpose is that it allows a user to segregate the water being poured during the refill process to one side of the lid and thereby one side of the drinking vessel, allowing the user to target tea substrate on one side of the cup.

### DESCRIPTION OF THE FIGURES

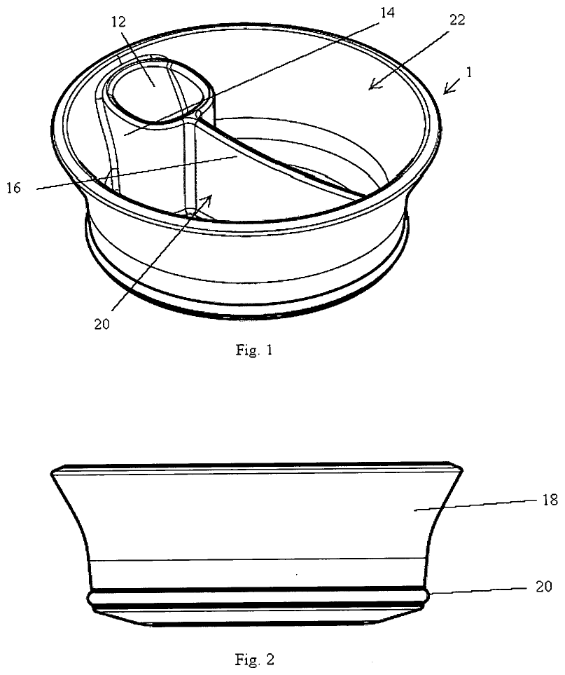

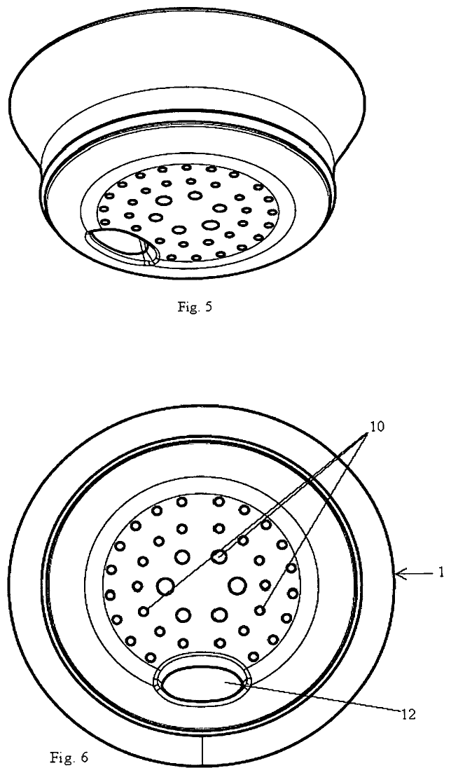

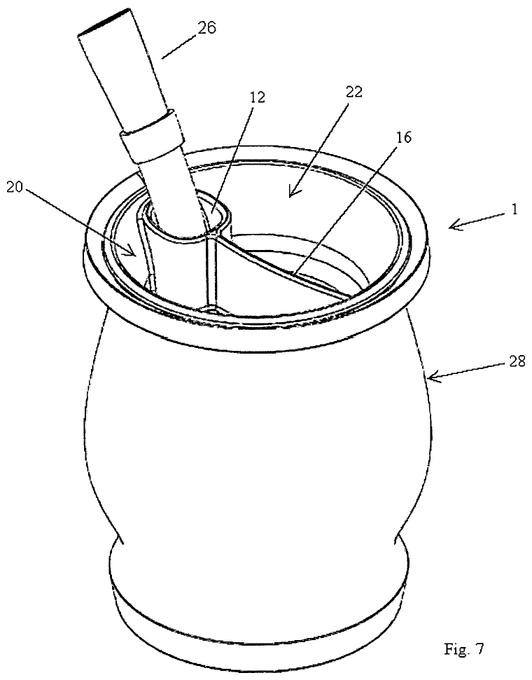

FIGS. 1-6 illustrate an embodiment of a mate lid 1. The mate lid 1 is configured for nesting engagement to a drinking vessel. The mate lid has a floor 3 and a wall 5 extending upward and away from the floor to provide a receptacle for water or other steeping liquid. In the depicted embodiment the wall is formed having a circular cross section. The floor 3 and wall form a lid receptacle into which a user places mate, and subsequently pours hot water into the receptacle. The mate lid floor 3 has a plurality of filter openings 10 configured such that the top is permeable to water. The filter openings serve to allow liquid poured in the lid to flow to the drinking vessel below, while maintaining the tea substrate below the lid, effectively controlling the rate at which the liquid flows through the lid to the tea substrate. The mate lid is configured for attachment to a drinking cup, glass, or other vessel. In the depicted embodiment the lid utilizes an o-ring 25 for a leak resistant nesting engagement with a drinking vessel, such as a drinking cup or glass. This allows the water or other steeping liquid to flow through the lid, put prevents the steeped tea and tea substrate from flowing back up through the lid. One or more dividing walls can extend upward from the floor to divide the lid receptacle into two or more sub receptacles. The instant embodiment depicts a single dividing wall 16 transecting the lid receptacle between the straw protuberance and the wall of the lid. In this embodiment a user can place mate into drinking vessel and selectively pour water into the compartments in the lid sequentially if desired, thus selectively directing water at a portion of the mate in the receptacle. This allows In the depicted embodiment the dividing wall provides a medial wall to divide the lid receptacle into two sub receptacles or compartments.

A straw support protuberance extends upward from the floor of the mate lid. The straw support protuberance forms an opening or straw opening 12 for a straw to be inserted through the lid into the cup or glass which the lid is attached. The strap support protuberance extends a distance above the floor of the mate lid to prevent liquid in the mate lid from traveling through the straw opening into the drinking vessel below. In the depicted embodiment the straw support protuberance is integrally formed with the dividing wall and serves as an extension of the dividing wall, effectively dividing the lid receptacle into two sub receptacles.

The plurality of openings 10 are preferably configured to be resistant to water coming back out of the openings 10 from inside the drinking vessel. The plurality of openings 10 can be of a variety of shapes and/or sizes. In the depicted embodiment the openings are different sizes and arranged so as to be configured to control the flow of liquid through the lid onto the tea substrate positioned in the drinking vessel below.

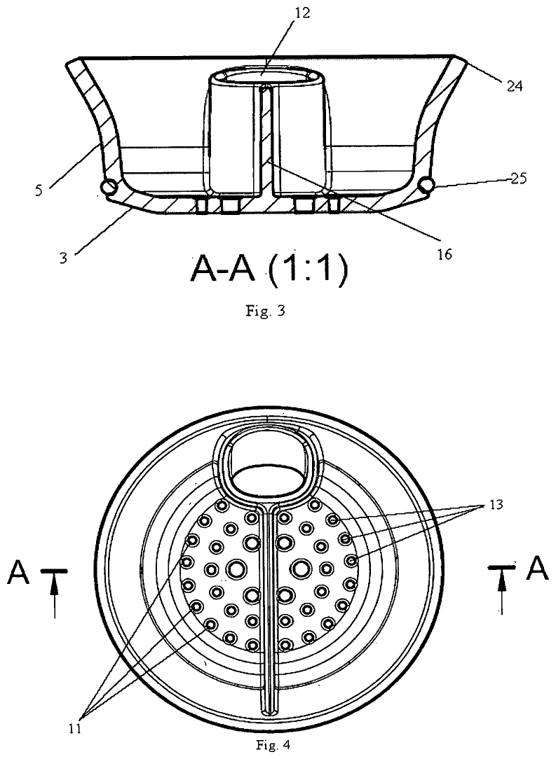

FIG. 2 illustrates the mate lid 1 configured for nesting engagement with a drinking vessel. The mate lid 1 has extended sidewalls 18 so as to fit securely inside a drinking vessel. Illustrated in FIG. 10, the shape of the extended sidewalls 18 are configured to match the shape of the drinking vessel. The bottom lip 20 of the mate lid 1 is configured to secure the mate lid 1 against the drinking vessel while fully inserted therein. FIG. 4 illustrates the mate lid 1 having a vertical divider 16 dividing the receptacle into two sub-receptacles 20, 22. The depicted vertical divider 16 transects the mate lid 1 device such that it extends from the back of the mate lid 1 to the straw opening 12. The vertical divider 16 is configured such that it segregates water being poured during the refill process to one side of the mate lid 1. This allows a user to spend the leaves on one side of the vessel while preserving the leaves on the other side. The vertical divider 16 also provides a gripping area such that a user can readily remove the mate lid 1 from a drinking vessel. The straw protuberance 14 has a straw opening 12. The depicted straw protuberance is integral with the vertical divider 16. The straw protuberance extends to the height of the vertical divider such that water placed in the receptacles 20, 22 does not flow out of the straw opening, and instead must travel through the filter openings. The straw protuberance and wall(s) of the lid provide a deep receptacle that allows a user to fill the lid with water and the water to steep in a controlled fashion onto the tea substrate below.

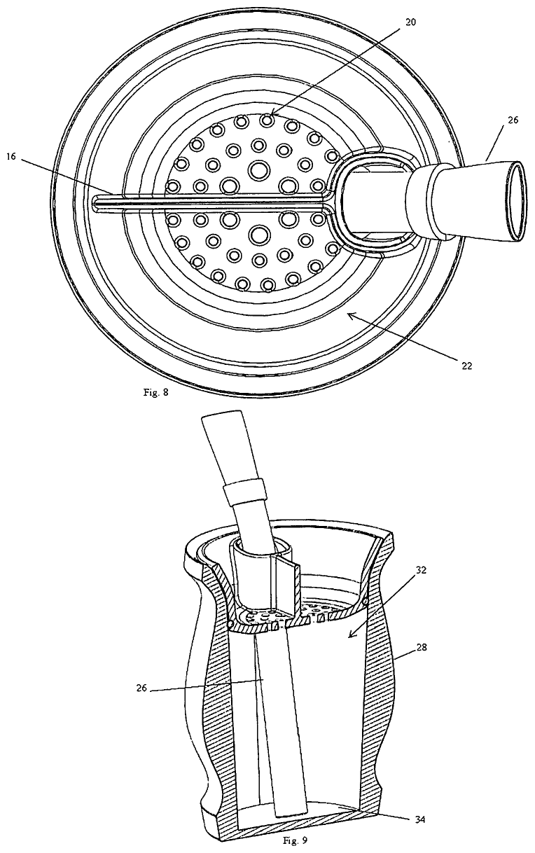

FIG. 7 illustrates a top perspective of the mate lid 1. FIG. 8 illustrates a perspective view of the mate lid 1 as attached to a drinking vessel. FIG. 9 illustrates the mate lid 1 as separated from the drinking vessel. FIG. 10 illustrates a cross sectional view of the mate lid 1. The mate lid 1 of FIG. 10 is illustrated having a vertical divider 16.

Still other features and advantages of the presently disclosed and claimed inventive concept(s) will become readily apparent to those skilled in this art from the following detailed description describing preferred embodiments of the inventive concept(s), simply by way of illustration of the embodiments contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is claimed is:

1. A removable lid for use with a drinking vessel, said removable lid comprising:
a lid floor defining a plurality of filter openings;
a wall extending upward from said floor to a lip, said wall and said lid floor defining a receptacle for liquid with said filter openings allowing said liquid to travel through said floor while retaining a tea substrate in a drinking vessel to which the removable lid is attached, wherein said wall is configured for engagement with a drinking vessel such that the lip of the wall is at or proximate to a lip of the drinking vessel; and
a straw protuberance extending upward from said floor and configured for insertion therethrough of a straw.

2. The drinking vessel and removable lid of claim 1 wherein said removable lid comprises an o-ring positioned on a perimeter of said lid and configured to provide a seal between said removable lid and an interior surface of said drinking vessel.

3. The drinking vessel and removable lid of claim 1, wherein said removable lid comprises a circular cross section.

4. The drinking vessel and removable lid of claim 1 further comprising a vertical divider, said vertical divider extending across said lid floor to divide said lid into at least two receptacles.

5. The drinking vessel and removable lid of claim 4 wherein said straw protuberance and said vertical wall are integral.

6. A drinking vessel and removable lid, said drinking vessel and removable lid comprising:
a vessel configured to retain a liquid and a tea substrate and comprising a bottom and a side wall extending upward from said bottom to a vessel lip at a top of said vessel;
a removable lid, said removable lid configured for nesting engagement with said drinking vessel, said lid comprising a lid floor and a lid wall extending from said floor to a lid lip and defining a receptacle for a liquid, said lid floor comprising a plurality of filter openings in said lid floor configured for flow therethrough of the liquid into said vessel, said lid comprising a straw protuberance extending upward from said floor and configured for insertion therethrough of a straw; and
wherein said straw comprising a first end and a second end, wherein said second end is configured for filtering a tea liquid from the tea substrate in said vessel when a user sucks said straw from said first end.

7. The drinking vessel and removable lid of claim 6 wherein said removable lid comprises an o-ring positioned on a perimeter of said lid and configured to provide a seal between said removable lid and an interior surface of said drinking vessel.

8. The drinking vessel and removable lid of claim 6 further comprising a straw.

9. The drinking vessel and removable lid of claim 6 wherein said removable lid comprises a circular cross section.

10. The drinking vessel and removable lid of claim 6 further comprising a vertical divider, said vertical divider extending across said lid floor to divide said lid into at least two receptacles.

11. The drinking vessel and removable lid of claim 10 wherein said straw protuberance and said vertical wall are integral.

12. The drinking vessel and removable lid of claim 6 wherein said drinking vessel defines a drinking vessel lip, wherein said removable lid defines a lid lip, wherein said lid lip is configured to engage said drinking vessel lip when said removable lid is nested with said drinking vessel.
